(19) United States
(12) Patent Application Publication
(10) Pub. No.: US 2025/0086516 A1
(43) Pub. Date: Mar. 13, 2025

(54) SERVER FOR UPDATING LEARNING MODEL OF ELECTRONIC DEVICE AND OPERATION METHOD THEREOF

(71) Applicant: SAMSUNG ELECTRONICS CO., LTD., Suwon-si (KR)

(72) Inventors: Hyunwoo KIM, Suwon-si (KR); Honghee Gil, Suwon-si (KR); Jinho Mun, Suwon-si (KR); Mihwa ` Park, Suwon-si (KR); Sungdeuk Park, Suwon-si (KR)

(73) Assignee: SAMSUNG ELECTRONICS CO., LTD., Suwon-si (KR)

(21) Appl. No.: 18/955,243

(22) Filed: Nov. 21, 2024

Related U.S. Application Data
(63) Continuation of application No. PCT/KR2023/004583, filed on Apr. 5, 2023.

(30) Foreign Application Priority Data
Jun. 30, 2022 (KR) 10-2022-0080478
Jul. 5, 2022 (KR) 10-2022-0082678

(51) Int. Cl. G06N 20/00; G06F 11/30; G06F 11/34

(52) U.S. Cl. CPC G06N 20/00; G06F 11/3006; G06F 11/3447

(57) ABSTRACT

A server includes: a communication interface configured to communicate with an external electronic device; at least one processor; and memory storing instructions that, when executed by the at least one processor, cause the server to: acquire one or more first performance levels of a first model of the external electronic device operatively connected to the server via the communication interface; train a second model based on determining the one or more first performance levels have declined; generate difference information based on differences between one or more second performance levels of the second model and the one or more first performance levels of the first model; transmit, to the external electronic device, the difference information via the communication interface; and transmit, to the external electronic device, the second model based on receiving, from the external electronic device, a first signal indicating that the second model is requested.

### CROSS-REFERENCE TO RELATED APPLICATIONS

This application is a by-pass continuation application of International Application No. PCT/KR2023/004583, filed on Apr. 5, 2023, which is based on and claims priority to Korean Patent Application No. 10-2022-0080478, filed in the Korean Intellectual Property Office on Jun. 30, 2022, and Korean Patent Application No. 10-2022-0082678, filed in the Korean Intellectual Property Office on Jul. 5, 2022, the disclosures of which are incorporated by reference herein in their entireties.

### FIELD

The disclosure relates to a server for updating a trained model stored in an electronic device and a method of operating the same.

### DESCRIPTION OF RELATED ART

It is expected that approximately 500 billion devices will be connected through 6G by 2030. Numerous devices such as smartphones, wearable devices, TVs, smart home appliances, and AI speakers may include trained models for performing various functions such as device operation, measurement, result prediction, content recommendation, and decision making. These models may be installed and utilized at the beginning of device production or consistently maintain increased performance through trained model updates from the server. Devices that continue use without updating the initially installed model may be unable to avoid deterioration in performance of the trained model that occurs over time due to a change in user behavior, a change in a peripheral environment of the device, or a change in data. In these situations, updating the trained model may become an essential element. Further, for devices that will increase exponentially in the future, it may be required to efficiently distribute trained models and provide an optimal performance.

An electronic device (e.g., server) may periodically train a second model and distribute the second model to a terminal at a fixed time period such as once a week or once a month. In the case that the server periodically trains a second model and distributes the second model to the terminal, even if a performance of a first model is not deteriorated, the server trains a second model each time and distributes the second model to the terminal, which may result in resource waste in both the server and the terminal. Further, the greater the number of terminals that download a second model, the greater the waste of a network resource used for transmitting the model from the server or receiving the model in the terminal.

The server may monitor a performance of the trained model and train a second model and distribute the second model to the terminal only in the case that the performance thereof is actually deteriorated. However, even in the case of monitoring the performance of the trained model and distributing a second model to the terminal, the server distributes the second model to all terminals in batches; thus, the second model may be distributed even to terminals that do not need to update the second model, which may actually lower a performance of the terminal.

### SUMMARY

According to an aspect of the disclosure, a server includes: a communication interface configured to communicate with an external electronic device; at least one processor; and memory storing instructions that, when executed by the at least one processor, cause the server to: acquire one or more first performance levels of a first model of the external electronic device operatively connected to the server via the communication interface; train a second model based on determining the one or more first performance levels have declined; generate difference information based on differences between one or more second performance levels of the second model and the one or more first performance levels of the first model; transmit, to the external electronic device, the difference information via the communication interface; and transmit, to the external electronic device, the second model based on receiving, from the external electronic device, a first signal indicating that the second model is requested.

The one or more first performance levels may be based on at least one of a data storage capacity, a computation speed, or a degree to which predicted results correspond to one or more third performance levels input by a user.

The at least one processor may be further configured to execute the instructions to cause the server to determine whether the second model is to be trained based on the one or more first performance levels.

The at least one processor may be configured to execute the instructions to cause the server to determine whether the one or more first performance levels have declined based on the one or more second performance levels exceeding one or more preconfigured levels compared to the one or more first performance levels.

The at least one processor may be configured to train the second model based on determining the one or more first performance levels have declined.

The at least one processor may be configured to execute the instructions to cause the server to store the difference information in the memory.

The at least one processor may be configured to execute the instructions to cause the server to detect changed data based on at least one of a change in user preference, an addition of new data, a change in time, or a change in season; and record the one or more first performance levels based on training the first model with the changed data.

The at least one processor may be configured to execute the instructions to cause the server to, based on training the first model with the changed data, train the second model, if one or more of the one or more first performance levels decline below a preconfigured level.

According to an aspect of the disclosure, an electronic device includes: a communication interface configured to communicate with a server; at least one processor; and memory storing instructions that, when executed by the at least one processor, cause the server to: acquire difference information from the server based on differences between one or more second performance levels of a second model and one or more first performance levels of a first model; determine whether to request an update to the second model based on the difference information; transmit, to the server, a signal indicating that the second model is requested based on determining to request the update; and receive, from the server, the second model.

The one or more first performance levels may be based on at least one of a data storage capacity, a computation speed, or a degree to which predicted results correspond to one or more third performance levels input by a user.

The at least one processor may be configured to execute the instructions to cause the electronic device to determine whether to request the second model based on the one or more first performance levels.

The at least one processor may be configured to execute the instructions to cause the electronic device to determine the one or more first performance levels have declined based on the one or more second performance levels exceeding one or more preconfigured levels compared to the one or more first performance levels.

The at least one processor may be configured to execute the instructions to cause the electronic device to transmit to the server, via the communication interface, information indicating that the second model is requested based on determining the one or more first performance levels have declined.

The at least one processor may be configured to execute the instructions to cause the electronic device to install the second model based on receiving the second model from the server.

The at least one processor may be configured to execute the instructions to cause the electronic device to: perform prediction using the second model based on installing the second model; and transmit feedback data indicating performance results of the second model to the server via the communication interface.

The at least one processor may be configured to execute the instructions to cause the electronic device to transmit to the server information indicating that the second model is requested based on a difference between a second data distribution of the second model and a first data distribution of the first model exceeding a predetermined level.

The electronic device of claim 9, wherein the at least one processor is configured to execute the instructions to cause the electronic device to: detect that a second prediction performance level of a first category has increased based on training being performed with the second model; and transmit information to the server indicating the second model is requested based on detecting a usage frequency of an application including a second category exceeds a predetermined level.

According to an aspect of the disclosure, a method of updating a model of an electronic device, performed by a server, includes: identifying declines in one or more first performance levels of a first model used in the electronic device; training a second model based on identifying the declines in the one or more first performance levels; generating difference information based on differences between the second model and the first model; transmitting the difference information to the electronic device; receiving a signal indicating that the second model is requested; and transmitting the second model based on receiving the signal indicating the second model is requested.

The declines in the one or more first performance levels may be based on at least one of a data storage capacity, a computation speed, or a degree to which predicted results correspond to one or more third performance levels input by a user.

The training the second model may include training the second model based on training changed data with the first model and one or more of the one or more first performance levels declining below a preconfigured level.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a block diagram illustrating an electronic device in a network environment according to one or more embodiments.

FIG. 2 illustrates a selective trained model distribution situation of a server according to one or more embodiments.

FIG. 3 is a block diagram illustrating a constitution of an electronic device and a server according to one or more embodiments.

FIG. 4 is a block diagram illustrating a trained model management system according to one or more embodiments.

FIG. 5A illustrates a change in input data distribution according to one or more embodiments.

FIG. 5B illustrates a process of comparing performances of a first model and a second model according to one or more embodiments.

FIG. 5C illustrates a process of determining whether to request a second model according to one or more embodiments.

FIG. 6 is a flowchart illustrating a method of managing a trained model of an electronic device according to one or more embodiments.

FIGS. 7A and 7B illustrate one or more embodiments of a trained model management method of an electronic device according to one or more embodiments.

### DETAILED DESCRIPTION

The embodiments described in the disclosure, and the configurations shown in the drawings, are only examples of embodiments, and various modifications may be made without departing from the scope and spirit of the disclosure.

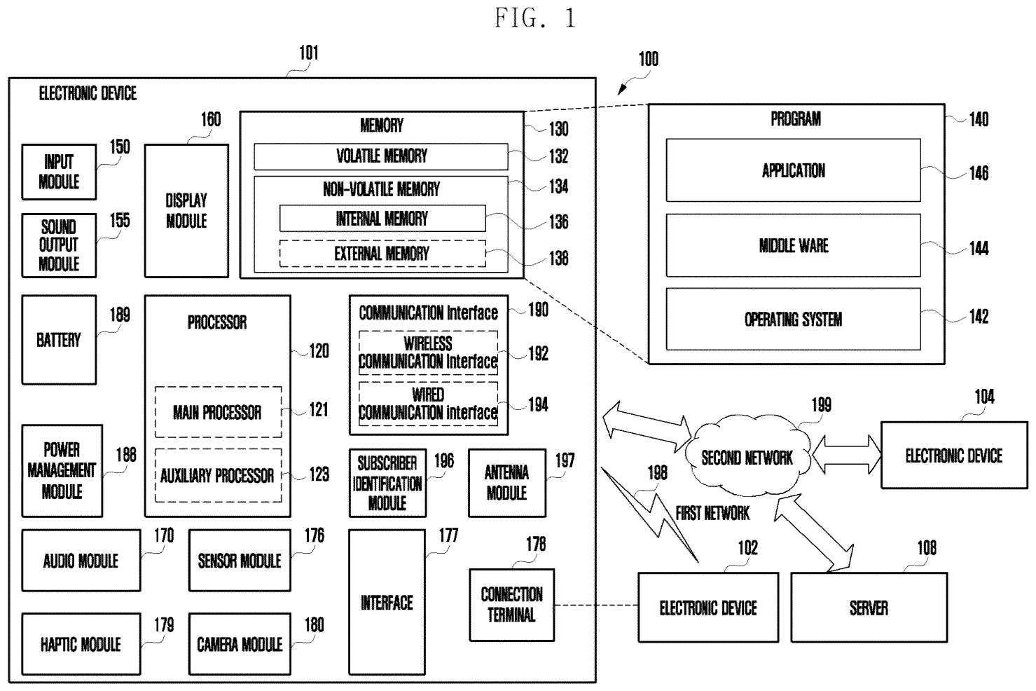

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication interface 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication interface 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication interface 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication interface 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication interface 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication interface 190 may include one or more communication processors that are operable independently from the processor 120 (e.g., the application processor (AP)) and supports a direct (e.g., wired) communication or a wireless communication. According to an embodiment, the communication interface 190 may include a wireless communication interface 192 (e.g., a cellular communication interface, a short-range wireless communication interface, or a global navigation satellite system (GNSS) communication interface) or a wired communication interface 194 (e.g., a local area network (LAN) communication interface or a power line communication (PLC) module). A corresponding one of these communication interfaces may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication interfaces may be implemented as a single component (e.g., a single chip), or may be implemented as multi components (e.g., multi chips) separate from each other. The wireless communication interface 192 may identify and authenticate the electronic device 101 in a communication network, such as the first network 198 or the second network 199, using subscriber information (e.g., international mobile subscriber identity (IMSI)) stored in the subscriber identification module 196.

The wireless communication interface 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication interface 192 may support a high-frequency band (e.g., the mm Wave band) to achieve, e.g., a high data transmission rate. The wireless communication interface 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication interface 192 may support various requirements specified in the electronic device 101, an external electronic device (e.g., the electronic device 104), or a network system (e.g., the second network 199). According to an embodiment, the wireless communication interface 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication interface 190 (e.g., the wireless communication interface 192) from the plurality of antennas. The signal or the power may then be transmitted or received between the communication interface 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

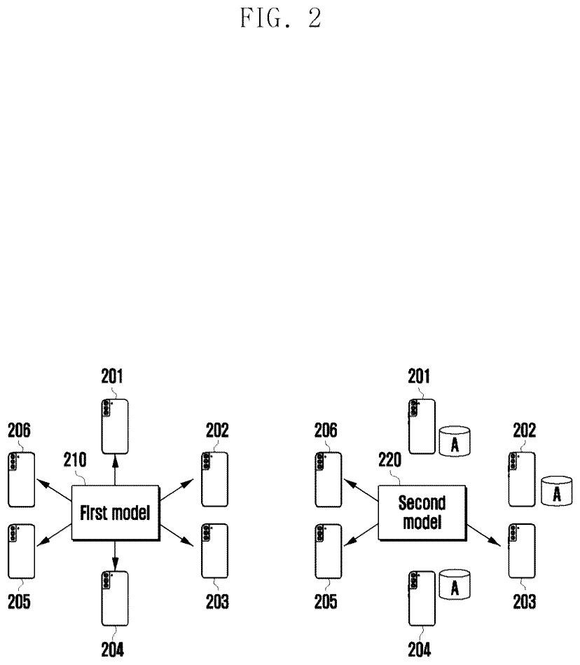

FIG. 2 illustrates a selective trained model distribution situation of a server according to one or more embodiments.

According to one or more embodiments, the server may perform various operations using a first model 210. For example, the first model 210 may receive input information according to a user input from UEs 201 to 206, generate output information based on the input information, and output the output information back to the UEs 201 to 206.

According to one or more embodiments, input information may mean information input to the first model 220 in order to perform an operation. Further, output information may mean the result of processing input information in the first model 220. The server may perform various operations based on the output information.

The first model 220 according to one or more embodiments may be one of at least one artificial intelligence model for performing various operations in the UEs 201 to 206. For example, the first model 220 may be an artificial intelligence model for various operations that may be performed in the UEs 201 to 206 such as a voice recognition model, a natural language processing model, and an image recognition model. The first model 220 may be one of various types of artificial intelligence models without being limited to the above-described example.

The UEs 201 to 206 according to one or more embodiments may be implemented in various forms. For example, the UEs 201 to 206 may include smart TVs, set-top boxes, mobile phones, tablet PCs, digital cameras, laptop computers, desktop computers, e-book readers, digital broadcasting terminals, personal digital assistants (PDAs), portable multimedia players (PMPs), navigation devices, MP3 players, wearable devices, and the like, but are not limited thereto.

According to one or more embodiments, in order to compensate for the above-described disadvantages of the first model 210, the server may provide information that may update the first model 210 to the UEs 201 to 206 using a second model 220 having increased performance compared to the first model 210. According to one or more embodiments, the first model 210 of the UEs 201 to 206 may be continuously updated based on information provided from the server. The updated first model 210 may output appropriate output information, as in the case of using the second model 220 with increased performance. The performance may mean any one of a data storage capacity, a computation speed, or a degree to which predicted results match results input by a user.

According to one or more embodiments, the second model 220 has a relatively larger size compared to the first model 210; thus, the probability of outputting output information appropriate for the user may be relatively higher. Because the second model 220 according to one or more embodiments may be processed by a server with a relatively high performance, the second model 220 may be an artificial intelligence model including a larger number of nodes and neural network layers than the first model 210.

According to the comparative example, the server may periodically train a second model at a fixed time period (e.g., once a week, once a month, and the like), and distribute the trained second model to the UEs 201 to 206. In this case, the server may distribute the first model 210 to all connected UEs 201 to 206 after a fixed time period. However, in this case, even in the case that a performance level of the first model has not declined, the UEs 201 to 206 may have to train a second model each time. In order to train and distribute a second model that is not needed, the servers and the UEs 201 to 206 may waste resources.

According to the comparative example, instead of periodically training a second model and distributing the second model to the UEs 201 to 206 at a fixed time period, the server may observe a performance level of the trained model, train a second model only in the case that it detects that the performance has declined below a predetermined level, and distribute the second model to the UEs 201 to 206. However, even in this case, because the server distributes a trained model in batches to all connected UEs 201 to 206, a performance of UEs that do not require updating of the trained model may actually be lowered.

According to one or more embodiments of this document, the server may transmit increases in one or more performance levels of a second model compared to the first model to the UEs 201 to 206, and transmit a second model only to UEs that request a second model based on receiving, from the UEs 201 to 206, a response requesting to update the model. For example, the server may transmit increases in one or more performance levels of the second model compared to the first model to the UEs 201 to 206. Some UEs 203, 205, and 206 of the UEs may determine to request a second model (e.g., the second model 220) to increase one or more performance levels, and transmit corresponding information to the server. The server may transmit a second model (e.g., the second model 220) based on the received information to some UEs 203, 205, and 206 of the UEs. A process in which the UE determines whether to request the second model will be described below.

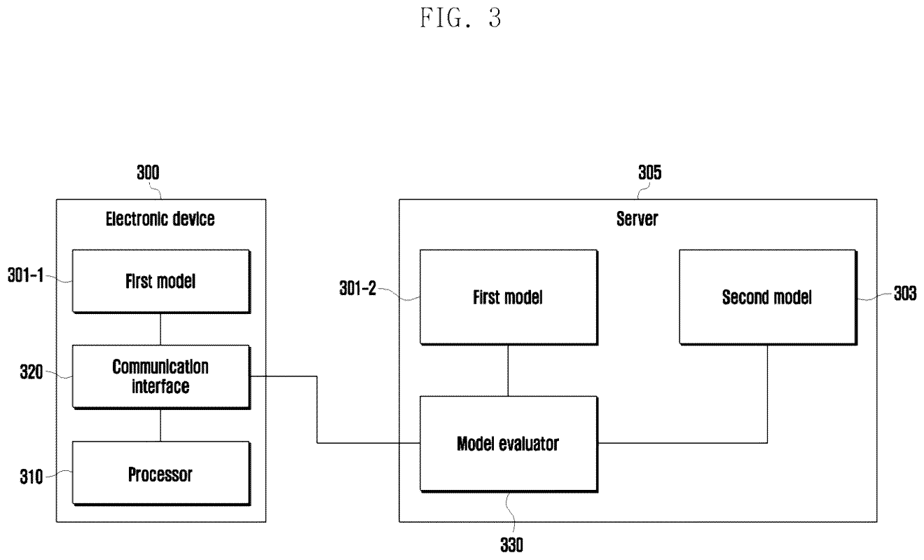

FIG. 3 is a block diagram illustrating a constitution of an electronic device and a server according to one or more embodiments.

According to one or more embodiments, an electronic device 300 may include a processor 310, a communication interface 320, and a first model 301-1, and some of the illustrated components may be omitted or replaced. The electronic device may further include at least some of the components and/or functions of the electronic device 101 of FIG. 1. At least some of the illustrated (or not illustrated) components of the electronic device may be operatively, functionally, and/or electrically connected to each other.

According to one or more embodiments, the processor 310 is a component capable of performing calculation or data processing related to the control and/or communication of each component of the electronic device, and may be composed of one or more processors. The processor 310 may include at least some of components and/or functions of the processor 120 of FIG. 1.

According to one or more embodiments, there will be no limitation to the calculation and data processing functions that the processor 310 may implement in the electronic device 300, but hereinafter, features related to the control of the trained model will be described in detail. Operations of the processor 310 may be performed by loading instructions stored in a memory (not illustrated).

According to one or more embodiments, the communication interface 320 may communicate with an external device through a wireless network under the control of the processor 310. The communication interface 320 may include hardware and software modules for transmitting and receiving data from cellular networks (e.g., long term evolution (LTE) network, 5G network, new radio (NR) network) and local area network (e.g., Wi-Fi, Bluetooth). The communication interface 320 may include at least some of the components and/or functions of the communication interface 190 of FIG. 1.

The electronic device 300 according to one or more embodiments may be implemented in various forms. For example, the electronic device 300 may include a smart TV, a set-top box, a mobile phone, a tablet PC, a digital camera, a laptop computer, a desktop computer, an e-book reader, a digital broadcasting terminal, a personal digital assistant (PDA), a portable multimedia player (PMP), a navigation device, an MP3 player, a wearable device, and the like, but are not limited thereto.

According to one or more embodiments, input information may mean information input to the first model 301-1 in order to perform an operation. Further, output information may mean the result of processing input information in the first model 301-1. The server may acquire output information of the first model 301-1. The server may perform various operations based on the output information of the first model 301-1. For example, the server may determine that one or more performance levels of the first model installed in the UE have declined based on the output information of the first model 301-1. The server may train a second model based on the determination that one or more performance levels of the first model have declined and distribute the second model to the UE.

The first model 301-1 according to one or more embodiments may be one of at least one artificial intelligence model for performing various operations in the electronic device 300. For example, the first model 301-1 may be an artificial intelligence model for various operations that may be performed in the electronic device 300 such as a voice recognition model, a natural language processing model, and an image recognition model. The first model 301-1 may be one of various types of artificial intelligence models without being limited to the above-described example.

According to one or more embodiments, a server 305 may transmit information related to update of the first model 301-1 to the communication interface 320 of the electronic device 300 using a second model 303 having one or more higher performance levels than that of a first model 301-2. The electronic device 300 may update the trained model using information related to update of the first model 301-1. According to one or more embodiments, the electronic device 300 may continuously update the trained model based on information provided from the server 305. The electronic device 300 may output output information corresponding to input information using the updated trained model (e.g., the second model 303).

According to one or more embodiments, an entity that performs training on a second model and an entity that distributes a second model may be the same or different. For example, the server 305 may perform training on a second model and transmit or distribute the second model to the electronic device 300 based on receiving a signal requesting the second model from the electronic device 300. The server 305 may perform training on a second model and transmit the second model to another server (not illustrated). Another server (not illustrated) that has received the second model may transmit or distribute the second model to the electronic device 300 based on a request from the electronic device 300.

The second model 303 according to one or more embodiments has a relatively larger size compared to the first model 301-2; thus, the probability of outputting output information appropriate for the user may be relatively higher. The second model 303 according to one or more embodiments may be processed by the server 305 with a relatively high performance; thus, the second model 303 may be an artificial intelligence model including a greater number of nodes and neural network layers than the first model 301-2.

According to one or more embodiments, the electronic device 300 may receive information indicating increases in one or more performance levels in a second model from a model evaluator 330 of the server 305 using the communication interface 320. The electronic device 300 may determine to request a second model based on information indicating increases in one or more performance levels in the second model. The electronic device 300 may request information on a second model to the server 305 based on determining to request an update for a second model. The server 305 may transmit information on a second model (e.g., the second model 303) to the electronic device 300 corresponding to a request from the electronic device 300. The electronic device 300 may update the trained model based on information received from the server 305.

According to one or more embodiments, the server 305 may identify differences or increases in one or more performance levels between the first model 301-2 and the second model 303 using the model evaluator 330. The first model 301-2 may mean the same model as a trained model (the first model 301-1) installed in the electronic device 300.

According to one or more embodiments, the server 305 is an artificial intelligence model, and may update the first model 301-2 mounted in the server 305 earlier than the electronic device 300 using the second model 303. According to one or more embodiments, the server 305 may update the first model 301-2 so that the same output information as output information output from the second model 303 may be output for the same input information. Further, the server 305 may acquire information for updating the first model 301-1 of the electronic device 300 based on the updated first model 301-2, and transmit the information to the electronic device 300. The electronic device 300 may transmit information indicating differences and one or more increases in performance levels between the first model 301-2 and the second model 303 to the electronic device 300.

According to one or more embodiments, when the distribution of data input to the trained model changes, increases in one or more performance levels may occur. In the case that a performance level of target class that is an analysis object of the trained model is increased, improvements in performance may occur. The server 305 may transmit the trained model with the increased performance level only to UEs that request an increase in a performance level of the class based on the increase in the performance level of a target class that is an analysis object of the trained model. The server 305 does not transmit the trained model to UEs that do not indicate a performance level of the corresponding class is to be increased, thereby saving resources of the server 305 and the UE.

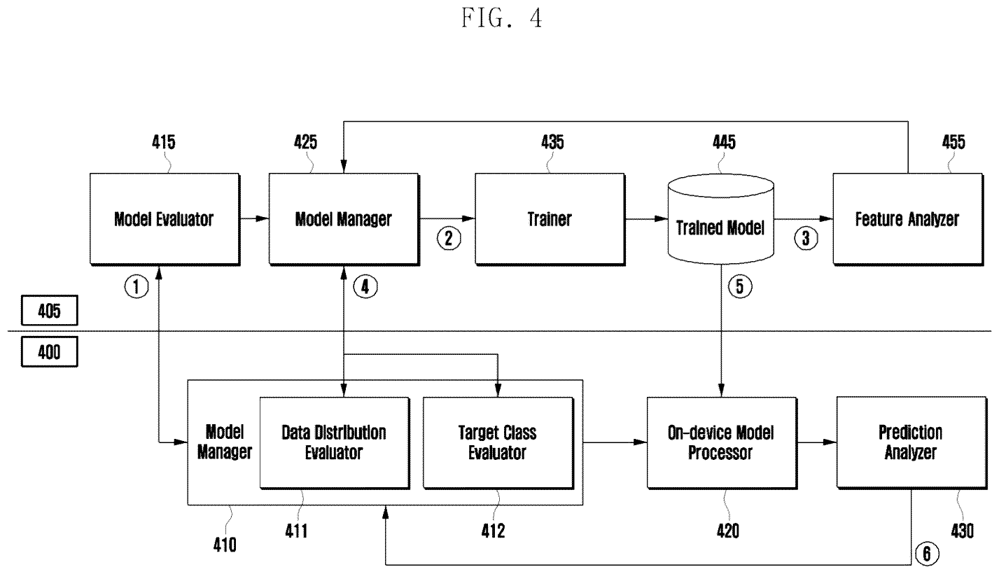

FIG. 4 is a block diagram illustrating a trained model management system

according to one or more embodiments.

A server 405 may include the server 305 of FIG. 3. An electronic device 400 may include the electronic device 300 of FIG. 3.

In operation (1), a model evaluator 415 of the server 405 (e.g., the server 305 of FIG. 3) may collect one or more current model performance levels of the electronic device 400 (e.g., the electronic device 300 of FIG. 3), and determine whether the electronic device 400 to request a second model based on the identification result of the one or more model performance levels.

In operation (2), the model evaluator 415 may control a trainer 435 to perform new training using a model manager 425 based on determining that a second model is to be trained.

In operation (3), the trainer 435 may train a second model 445. A feature analyzer 455 may analyze increases in one or more performance levels in the second model 445 and a first model and store the performance level increases in the model manager 425.

In operation (4), the model manager 425 may compare the first model of the electronic device 400 with the second model thereof and transmit the performance level increases to the electronic device 400. A model manager 410 of the electronic device 400 may determine whether data distribution of the second model and data distribution of the first model are similar using an input data distribution evaluator 411. The model manager 410 of the electronic device 400 may determine whether a performance level of a target class of the second model has increased using a target class evaluator 412 and determine whether a performance level of the target class is to be increased. According to one or more embodiments, the electronic device 400 may analyze the user's use pattern and determine that the performance level of the target class is to be increased based on using the target class with the increased performance level with or greater than a predetermined frequency.

According to one or more embodiments, the electronic device 400 may transmit

to the server 405 information indicating that a second model 445 is requested based on determining the performance level of the target class is to be increased.

In operation (5), a processor 420 of the electronic device 400 may download a second model 445 from the server 405 and update the trained model in the electronic device 400. According to the comparative example, even in the case that there is no need to update the trained model, the electronic device may download the second model 445 to waste resources. The electronic device 400 according to one or more embodiments may download only information indicating increases in one or more performance levels of the second model, not the second model from the server 405, determine whether to update the trained model, and download the second model 445 to avoid wasting resources.

In operation (6), the electronic device 400 may perform prediction using a trained model using a prediction analyzer 430 and transmit feedback data to the model manager 410 of the electronic device 400. The model manager 410 of the electronic device 400 may determine a time point to update the trained model based on the received feedback data.

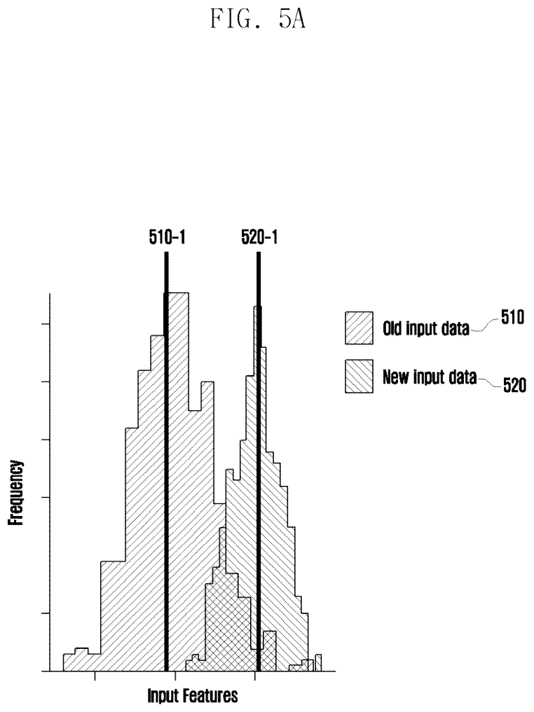

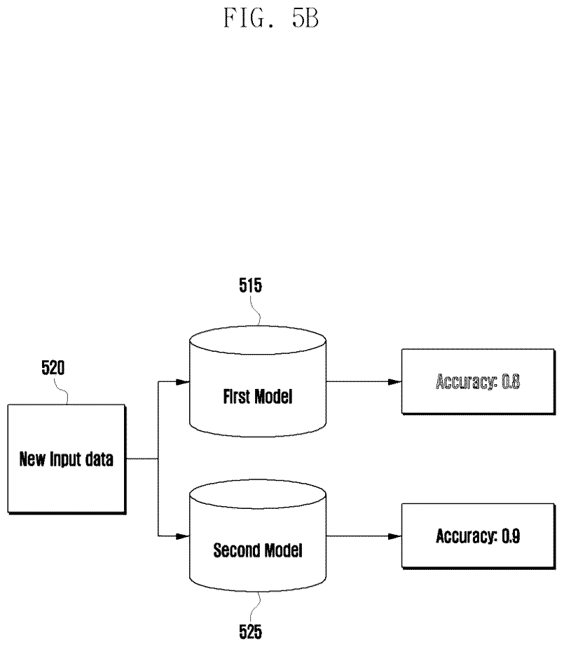

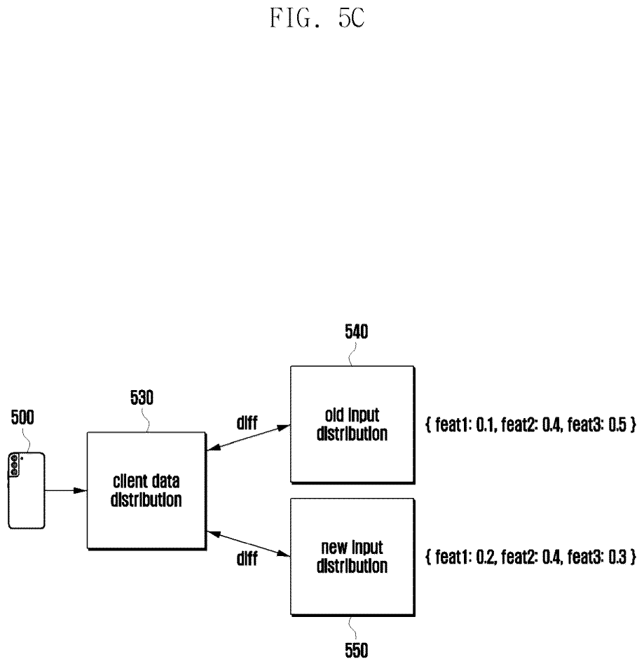

FIG. 5A illustrates a change in input data distribution according to one or more embodiments. FIG. 5B illustrates a process of comparing performance levels of a first model and a second model according to one or more embodiments. FIG. 5C illustrates a process of determining whether to request a second model according to one or more embodiments.

With reference to FIG. 5A, in the case that distributions of old data and new data differ beyond a predetermined level, when the first model is used as it is, the server (e.g., the server 405 of FIG. 4) may determine that analysis of the new data is impossible.

For example, in the case that distribution 510-1 of old data 510 and distribution 520-1 of new data 520 differ beyond a predetermined level based on the horizontal axis, when the first model is used as it is, the server 405 may determine that analysis of new data is impossible. The horizontal axis is an input feature, which may mean, for example, used words or phrases. The vertical axis may indicate the frequency in which the input feature is used.

With reference to FIG. 5B, the server 405 may analyze the new data 520 using a first model 515 and the second model 525 based on the new data 520 being input. When the distribution of input data is changed due to a change in an external situation, the first model 515 may represent one or more relatively low performance levels compared to the second model 525. For example, the first model 515 has a probability of predicting use of new data 520 of 0.8, while the second model 525 has a probability of predicting use of new data 520 of 0.9, which may be relatively high. The server 405 may record a performance difference between the first model 515 and the second model 525 and transmit the performance difference to an electronic device 500. The electronic device 500 may include the electronic device 400 of FIG. 4. The electronic device 500 may determine whether to request a second model 525 based on information on the received performance difference.

With reference to FIG. 5C, the electronic device 500 may determine which data distribution of the first model 515 and the second model 525 is relatively more similar to current data distribution 530 of the electronic device 500. The electronic device 500 may calculate a numerical value for a degree to which the data distribution is similar for each target class based on information indicating the data distribution 530. The calculated numerical value may be relatively high as the data distribution is similar. The electronic device 500 may use a probability distribution distance metric including kolmogorov-smirnov test, kullback-leibler divergence, and population stability index when determining similarity. In the case that the distribution of currently used data is relatively more similar to the data distribution of the second model compared to that of the first model, the electronic device 500 may download and update the second model.

For example, the data distribution 530 may be classified into a first class, a second class, and a third class. Old data distribution 540 according to the first model 515 may indicate 0.1 for the first class, 0.4 for the second class, and 0.5 for the third class. New data distribution 550 according to the second model 525 may indicate 0.2 for the first class, 0.4 for the second class, and 0.3 for the third class. The electronic device 500 may identify that both the old data distribution 540 and the new data distribution 550 have the same similarity for the second class. The electronic device 500 may compare the first class and the third class to determine whether the current data distribution is more similar to the old data distribution 540 or the new data distribution 550.

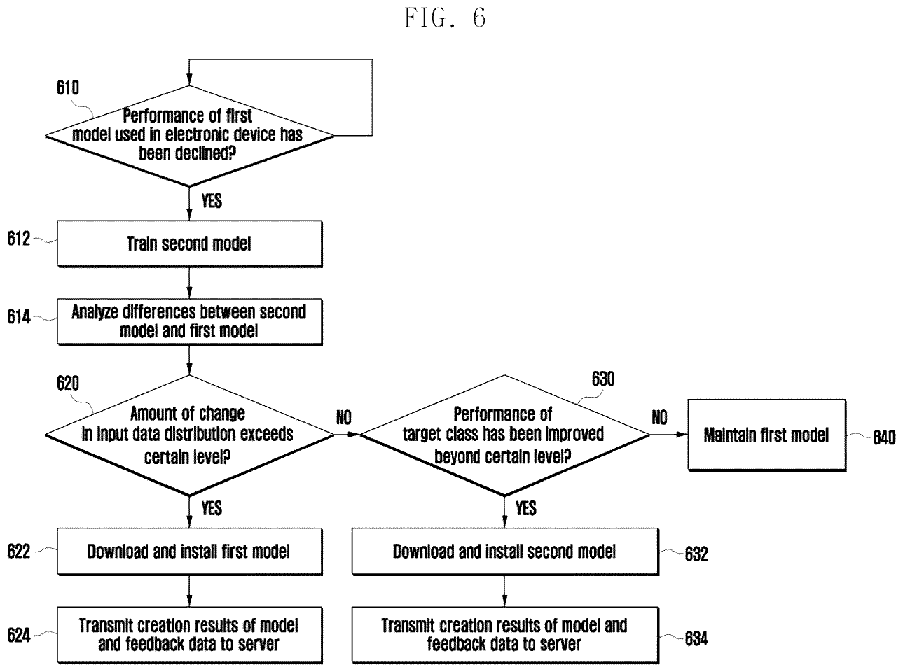

FIG. 6 is a flowchart illustrating a method of managing a trained model of an electronic device according to one or more embodiments.

An illustrated method 600 may be executed by the electronic device (e.g., the electronic device 400 of FIG. 4) or the server (e.g., the server 405 of FIG. 4) previously described with reference to FIGS. 1 to 5C, and technical features that have been described will be omitted below.

In operation 610, the server (e.g., the server 405 of FIG. 4) may identify whether one or more performance levels of a trained model used in the electronic device (e.g., the electronic device 400 of FIG. 4) have declined below a predetermined level. The trained model may mean at least one artificial intelligence model for performing various operations within the electronic device 400. For example, the trained model may mean any one of a speech recognition model, a natural language processing model, or an image recognition model. The trained model may be one of various types of artificial intelligence models without being limited to the above-described example.

In operation 612, the server 405 may train a second model. The server 405 may train a second model using a model manager (e.g., the model manager 425 of FIG. 4). This process has been described in operation 2 of FIG. 4.

In operation 614, the server 405 may analyze differences between the second model and the first model. The server 405 may store the analyzed differences or increases in one or more performance levels in a feature analyzer (e.g., the feature analyzer 455 of FIG. 4). This process has been described in operation 3 of FIG. 4.

In operation 620, the server 405 may identify whether an amount of change in the input data distribution exceeds a predetermined level. In operation 622, the server 405 may transmit a second model to the electronic device 400 based on the amount of change in the input data distribution exceeding a predetermined level. This has been described in operations 4 and 5 of FIG. 4. The electronic device 400 may download a second model from the server 405 and install the second model. The electronic device 400 may download a second model from the server 405 and update the trained model installed therein. In operation 624, the electronic device 400 may transmit creation results of the second model and feedback data to the server 405. This has been described in operation 6 of FIG. 4.

In operation 630, the server 405 may identify whether a performance level of a target class has increased beyond a predetermined level based on the fact that the amount of change in the input data distribution does not exceed a predetermined level. The target class may mean an analysis object of the trained model. In the case the performance level of the target class is to be increased based on the target class rather than all data, the electronic device 400 may transmit, to the server 405, information indicating that a second model is requested.

In operation 632, the server 405 may transmit a second model to the electronic device 400 based on identifying that the performance level of the target class has increased beyond a predetermined level. This has been described in operations 4 and 5 of FIG. 4. The electronic device 400 may download a second model from the server 405 and install the second model. The electronic device 400 may download a second model from the server 405 and update the trained model installed therein. In operation 634, the electronic device 400 may transmit creation results of the second model and feedback data to the server 405. This has been described in operation 6 of FIG. 4.

In operation 640, the server 405 may not transmit the second model to the electronic device 400 based on identifying that the performance level of the target class has not increased beyond a predetermined level. The server 405 may control the electronic device 400 to maintain the first model.

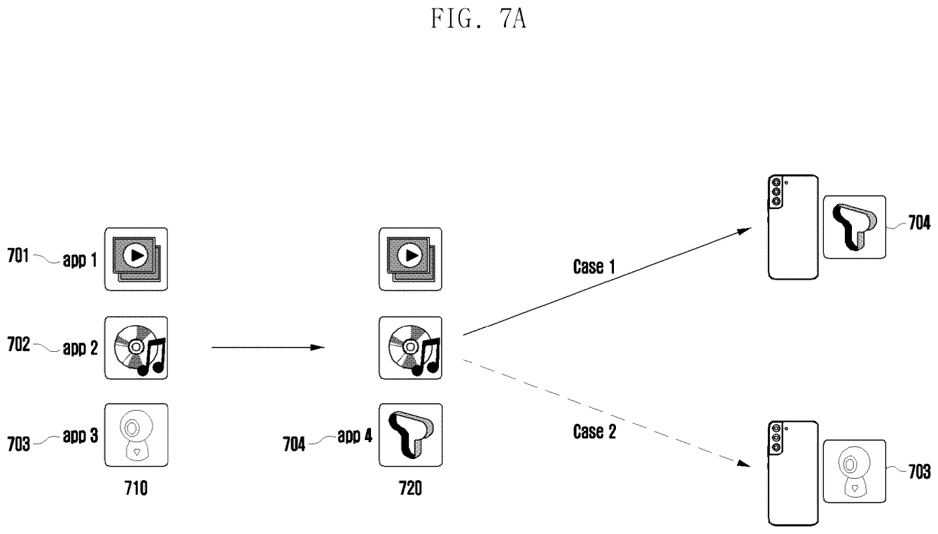

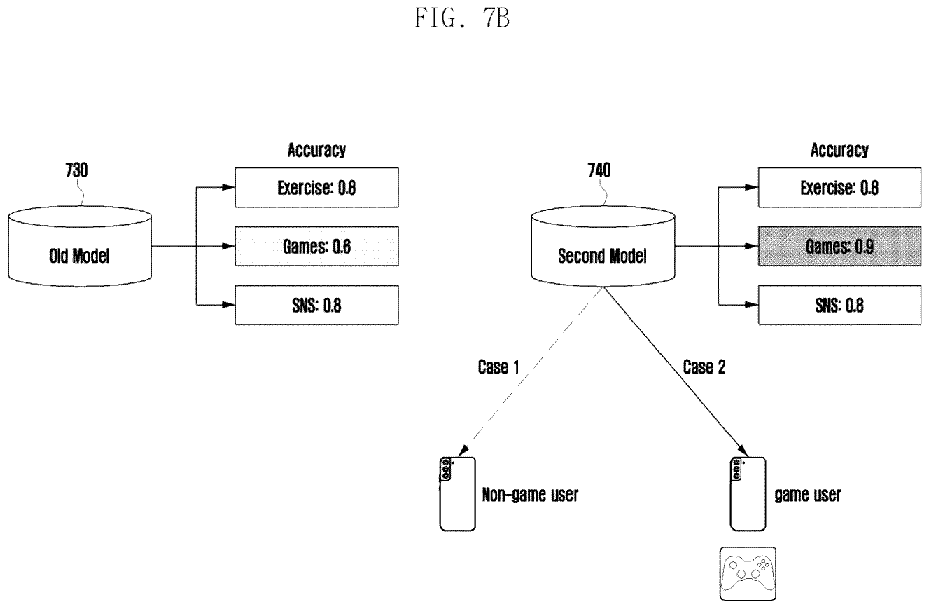

FIGS. 7A and 7B illustrate one or more embodiments of a trained model management method of an electronic device according to one or more embodiments.

With reference to FIG. 7A, an electronic device (e.g., the electronic device 400 of FIG. 4) may perform training on a first application 701, a second application 702, and a third application 703 using a trained model (e.g., the first model 301-1 of FIG. 3) and predict output results. The electronic device 400 may predict output results using the trained model and provide features (e.g., words, phrases, and the like) predicted to be selected by the user.

According to one or more embodiments, the electronic device 400 may detect a change from an old data use situation 710 to a new data use situation 720 in which a new fourth application 704 is used. The electronic device 400 may detect the use of a fourth application 704 used in the new data use situation 720 instead of a third application 703 used in the old data use situation 710.

According to one or more embodiments, when the electronic device 400 does not proceed new training including the fourth application 704 in the new data use situation 720, it may be difficult for the electronic device 400 to provide a prediction result appropriate for the new data use situation 720. The server 405 may transmit information indicating the difference between the second model and the first model to the electronic device 400 based on the change to the new data usage situation 720.

According to one or more embodiments, the electronic device 400 may determine whether a second model is to be requested in the new data use situation 720 based on received information. For example, a model manager (e.g., the model manager 410 of FIG. 4) of the electronic device 400 may determine whether data distribution of the second model and data distribution of the first model are similar using an input data distribution evaluator (e.g., the input data distribution evaluator 411 of FIG. 4).

According to one or more embodiments, the electronic device 400 may transmit to the server 405 information indicating that a second model including the fourth application 704 is to be requested based on a difference between data distribution of the second model and data distribution of the first model exceeding a predetermined level (case 1). In this case, the electronic device 400 may download a second model from the server 405 and install the second model inside the electronic device 400. The electronic device 400 may transmit to the server 405 information indicating not to transmit a second model based on the difference between data distribution of the second model and data distribution of the first model being less than a predetermined level (case 2). In this case, the electronic device 400 may maintain the first model.

With reference to FIG. 7B, the electronic device 400 may identify that a first model 730 has performance levels indicating exercise=0.8, games=0.6, and SNS=0.8. The electronic device 400 may predict output results using the first model 730 and provide features (e.g., words, phrases, and the like) predicted to be selected by the user. The performance levels may mean accuracy when providing features (e.g., words, phrases, and the like) predicted to be selected by the user.

In a situation where the server 405 analyzes old data using a second model 740, the server 405 may identify that the second model 740 has performance levels indicating exercise=0.8, games=0.9, and SNS=0.8. The server 405 may determine that a performance level of games has increased in the case of using the second model 740 compared to the first model 730. The server 405 may transmit information indicating increases in one or more performance levels when using the second model 740 compared to the first model 730 to the electronic device 400.

According to one or more embodiments, the electronic device 400 may receive information indicating increases in one or more performance levels from the server 405 and determine whether to request a second model 740. For example, the electronic device 400 may identify that the frequency in which the user uses an application including a games category is less than a predetermined level. In this case, the electronic device 400 may determine that even if the second model 740 is used, the increases in one or more performance levels are relatively low compared to the case of using the first model 730. The electronic device 400 may not transmit information requesting a second model 740 to the server 405.

Conversely, the electronic device 400 may identify that the frequency in which the user uses an application including the games category exceeds a predetermined level. In this case, the electronic device 400 may determine that when the second model 740 is used, the increase in performance levels will be relatively greater compared to the case of using the first model 730. The electronic device 400 may transmit information requesting a second model 740 to the server 405.

The electronic device 400 and the server 405 according to one or more embodiments do not uniformly determine the whether a second model 740 is to be acquired, but determine whether the second model 740 is to be acquired based on the frequency and category type of an application used within the electronic device 400. The server 405 may transmit the second model 740 to the electronic device 400 that requested the second model 740 to save resources. The server 405 may provide the electronic device 400 with information indicating differences from the first model 730, rather than information indicating the second model 740. Based on the received information, the electronic device 400 may accurately determine whether a second model 740 is to be requested while utilizing few resources. The electronic device 400 may determine not to request a second model 740 from the server 405 based on the received information.

A server according to one or more embodiments may include a communication interface configured to communicate with an external electronic device; and a processor, wherein the processor may be configured to acquire one or more performance levels of a first model of the external electronic device operatively connected to the server using the communication interface, to train a second model based on determination that one or more performance levels of the first model of the external electronic device have declined, to generate information including differences between the second model and the first model, to transmit information including the differences to the external electronic device using the communication interface, and to transmit the second model to the external electronic device based on receiving a first signal indicating that a trained model with one or more increased performance levels is requested from the external electronic device.

According to one or more embodiments, the performance levels of a trained model may mean one or more of a data storage capacity, a computation speed, or a degree to which predicted results match results input by a user.

According to one or more embodiments, the processor may be configured to determine the whether the second model is to be trained based on one or more performance levels of the first model of the external electronic device.

According to one or more embodiments, the processor may be configured to determine whether one or more performance levels of the first model have declined based on one or more performance levels of the second model of the external electronic device exceeding preconfigured levels compared to the performance of the first model.

According to one or more embodiments, the processor may be configured to proceed training of the second model based on determination that one or more performance levels of the first model have declined.

According to one or more embodiments, the processor may be configured to control to acquire information indicating a difference between the second model and the first model and to store the information in the memory.

According to one or more embodiments, the processor may be configured to control to detect a change in data based on any one of a change in user preference, addition of new data, a change in time, or a change in season, and to record one or more performance levels when training changed data using the first model.

According to one or more embodiments, the processor may be configured to control to train the second model, if one or more performance levels decline below a preconfigured level, when training changed data using the first model.

According to one or more embodiments, an electronic device may include a communication interface configured to communicate with a server; and a processor, wherein the processor may be configured to acquire information including a performance difference between a second model and a first model from the server, to determine whether an update to the second model is to be requested based on information including the performance difference between the second model and the first model, to transmit, to the server, a signal indicating that the second model is requested based on determining to request the update, and to receive the second model from the server.

According to one or more embodiments, the processor may be configured to perform prediction using the second model based on installing the second model inside the electronic device, to perform prediction using the second model, and to transmit feedback data indicating performance results to the server using the communication interface.

According to one or more embodiments, the processor may be configured to transmit information to the server indicating that the second model is requested based on a difference between data distribution of the second model and data distribution of the first model exceeding a predetermined level.

According to one or more embodiments, in the case that training is performed using the second model, the processor may be configured to detect that a prediction performance level of a category has increased, and to transmit information to the server indicating that the second model is requested based on detecting a frequency in which a user uses an application including a category exceeds a predetermined level.

A method of updating a trained model for an electronic device according to one or more embodiments may include identifying whether one or more performance levels of a first model used in the electronic device have declined; training a second model based on identifying a decline in one or more performance levels of the first model; analyzing a difference in one or more performance levels between the second model and the first model; transmitting the difference to the electronic device; receiving a signal indicating that the second model is requested; and transmitting the second model based on the signal indicating that the second model is requested.

According to one or more embodiments, training a second model based on identifying a decline in one or more performance levels of the first model may further include controlling to train the second model when one or more performance levels decline below a preconfigured level when training changed data using the first model.

What is claimed is:

1. A server, comprising:
a communication interface configured to communicate with an external electronic device;
at least one processor; and
memory storing instructions that, when executed by the at least one processor, cause the server to:
acquire one or more first performance levels of a first model of the external electronic device operatively connected to the server via the communication interface;
train a second model based on determining the one or more first performance levels have declined;
generate difference information based on differences between one or more second performance levels of the second model and the one or more first performance levels of the first model;
transmit, to the external electronic device, the difference information via the communication interface; and
transmit, to the external electronic device, the second model based on receiving, from the external electronic device, a first signal indicating that the second model is requested.

2. The server of claim 1, wherein the one or more first performance levels are based on at least one of a data storage capacity, a computation speed, or a degree to which predicted results correspond to one or more third performance levels input by a user.

3. The server of claim 2, wherein the at least one processor is further configured to execute the instructions to cause the server to determine whether the second model is to be trained based on the one or more first performance levels.

4. The server of claim 3, wherein the at least one processor is configured to execute the instructions to cause the server to determine whether the one or more first performance levels have declined based on the one or more second performance levels exceeding one or more preconfigured levels compared to the one or more first performance levels.

5. The server of claim 4, wherein the at least one processor is configured to train the second model based on determining the one or more first performance levels have declined.

6. The server of claim 1, wherein the at least one processor is configured to execute the instructions to cause the server to store the difference information in the memory.

7. The server of claim 1, wherein the at least one processor is configured to execute the instructions to cause the server to:
detect changed data based on at least one of a change in user preference, an addition of new data, a change in time, or a change in season; and
record the one or more first performance levels based on training the first model with the changed data.

8. The server of claim 7, wherein the at least one processor is configured to execute the instructions to cause the server to, based on training the first model with the changed data, train the second model, if one or more of the one or more first performance levels decline below a preconfigured level.

9. An electronic device, comprising:
a communication interface configured to communicate with a server;
at least one processor; and
memory storing instructions that, when executed by the at least one processor, cause the server to:
acquire difference information from the server based on differences between one or more second performance levels of a second model and one or more first performance levels of a first model;
determine whether to request an update to the second model based on the difference information;
transmit, to the server, a signal indicating that the second model is requested based on determining to request the update; and
receive, from the server, the second model.

10. The electronic device of claim 9, wherein the one or more first performance levels are based on at least one of a data storage capacity, a computation speed, or a degree to which predicted results correspond to one or more third performance levels input by a user.

11. The electronic device of claim 10, wherein the at least one processor is configured to execute the instructions to cause the electronic device to determine whether to request the second model based on the one or more first performance levels.

12. The electronic device of claim 11, wherein the at least one processor is configured to execute the instructions to cause the electronic device to determine the one or more first performance levels have declined based on the one or more second performance levels exceeding one or more preconfigured levels compared to the one or more first performance levels.

13. The electronic device of claim 12, wherein the at least one processor is configured to execute the instructions to cause the electronic device to transmit to the server, via the communication interface, information indicating that the second model is requested based on determining the one or more first performance levels have declined.

14. The electronic device of claim 9, wherein the at least one processor is configured to execute the instructions to cause the electronic device to install the second model based on receiving the second model from the server.

15. The electronic device of claim 14, wherein the at least one processor is configured to execute the instructions to cause the electronic device to:
perform prediction using the second model based on installing the second model; and
transmit feedback data indicating performance results of the second model to the server via the communication interface.

16. The electronic device of claim 9, wherein the at least one processor is configured to execute the instructions to cause the electronic device to transmit to the server information indicating that the second model is requested based on a difference between a second data distribution of the second model and a first data distribution of the first model exceeding a predetermined level.

17. The electronic device of claim 9, wherein the at least one processor is configured to execute the instructions to cause the electronic device to:
detect that a second prediction performance level of a first category has increased based on training being performed with the second model; and
transmit information to the server indicating the second model is requested based on detecting a usage frequency of an application comprising a second category exceeds a predetermined level.

18. A method of updating a model of an electronic device, performed by a server, comprising:
identifying declines in one or more first performance levels of a first model used in the electronic device;
training a second model based on identifying the declines in the one or more first performance levels;
generating difference information based on differences between one or more second performance levels of the second model and the one or more first performance levels of the first model;
transmitting the difference information to the electronic device;
receiving a signal indicating that the second model is requested; and
transmitting the second model based on receiving the signal indicating the the second model is requested.

19. The method of claim 18, wherein the declines in the one or more first performance levels are based on at least one of a data storage capacity, a computation speed, or a degree to which predicted results correspond to one or more third performance levels input by a user.

20. The method of claim 18, wherein the training the second model comprises training the second model based on training changed data with the first model and one or more of the one or more first performance levels declining below a preconfigured level.
